(19) United States
(12) Patent Application Publication
(10) Pub. No.: US 2021/0011947 A1
(43) Pub. Date: Jan. 14, 2021

(54) GRAPHICAL RENDERING OF AUTOMATA STATUS

(71) Applicant: International Business Machines Corporation, Armonk, NY (US)

(72) Inventors: Anuradha Bhamidipaty, Yorktown Heights, NY (US); Debasisha Padhi, Bangalore (IN); Sarin K. Thayyilsubramanian, Bangalore (IN)

(21) Appl. No.: 16/510,444

(22) Filed: Jul. 12, 2019

(51) Int. Cl. G06F 16/904; G06F 16/23; G06F 16/28; G06F 11/30

(52) U.S. Cl. CPC G06F 16/904; G06F 11/3006; G06F 16/28; G06F 16/2358

(57) ABSTRACT

A method for generating a graphical view of automata execution by an automatonic information technology (IT) management tool configured to monitor an IT infrastructure, where the tool includes a configuration items (CI) database containing configuration items that represent elements of the IT infrastructure, the tool including an execution log database configured to store automata execution status resulting from automatonic monitoring of the configuration items by the tool. The method includes collecting CI information values from the CI database, projecting the collected CI values into a template of a graphical view of the IT infrastructure generated by the tool, collecting state information values of the automata execution status from the execution log database, converting the state information values of the automata execution status into a graphic information and displaying the graphic information of the automata execution status on the graphical view of the IT infrastructure.

### BACKGROUND OF THE INVENTION

This disclosure is directed to computers, and computer applications, and more particularly to computer-implemented methods and systems for management of information technology services.

Status of automata execution, provided by an automation tool, is typically recorded in log format. Only those familiar with the automation tool can understand the log information as it lists the errors and failure codes that are specific for that tool. Even a technical person not familiar with that tool can find it difficult to understand the status of the execution when there errors. This leads to confusion and a communication gap between the account user and the developer because the account user might not be familiar with the log formats.

### SUMMARY OF THE INVENTION

In one embodiment, a method for generating a graphical view of automata execution by an automatonic information technology (IT) management tool configured to monitor an IT infrastructure is disclosed, where the tool includes a configuration items (CI) database containing configuration items that represent elements of the IT infrastructure, the tool including an execution log database configured to store automata execution status resulting from automatonic monitoring of the configuration items by the tool. The method includes collecting CI information values from the CI database, projecting the collected CI values into a template of a graphical view of the IT infrastructure generated by the tool, collecting state information values of the automata execution status from the execution log database, converting the state information values of the automata execution status into a graphic information and displaying the graphic information of the automata execution status on the graphical view of the IT infrastructure.

A system that includes one or more processors operable to perform one or more methods described herein also may be provided.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a block diagram of one embodiment of the system disclosed in this specification.

FIG. 2 is a flow diagram of one embodiment of the method disclosed in this specification.

FIG. 3 is depicts a graphical view of an IT infrastructure generated by the method and system of FIG. 1 or 2.

FIG. 4 depicts a cloud computing environment according to an embodiment of the present invention.

FIG. 5 depicts abstraction model layers according to an embodiment of the present invention.

FIG. 6 is a block diagram of an exemplary computing system suitable for implementation of the embodiments of the invention disclosed in this specification.

### DETAILED DESCRIPTION OF PREFERRED EMBODIMENTS

In one embodiment, rendering in a graphical format the operation of an automation tool is disclosed. In one embodiment, the graphical view is simple and intuitive to understand for a technical person as well as a management executive. In one embodiment, the graphical rendering of the automation execution includes the ability to view details based on the role of the user.

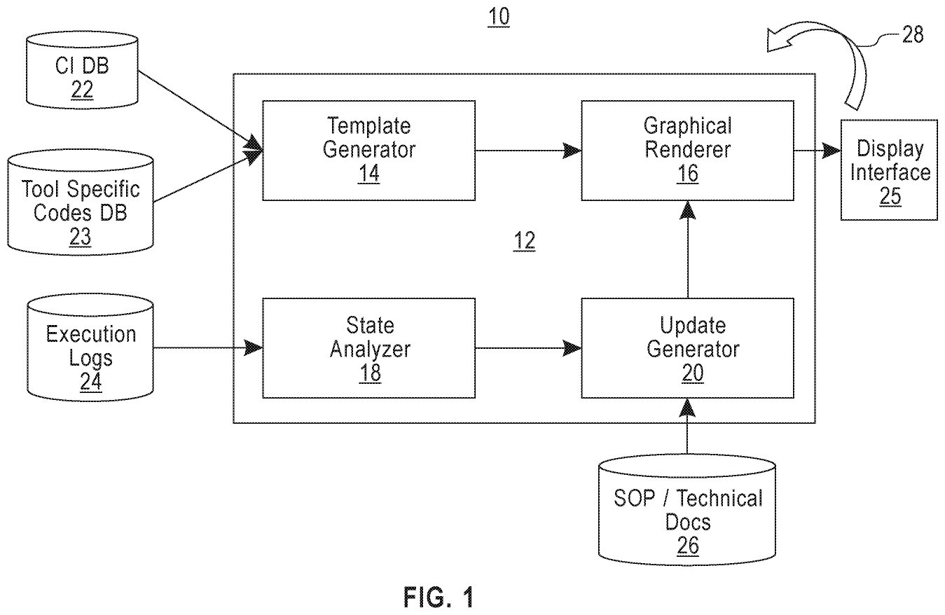

FIG. 1 is a block diagram of one embodiment a system for graphical rendering of automata execution. The automata execution graphical rendering system 10 includes computer processing system 12 that includes template generator 14, graphical renderer 16, state analyzer 18 and update generator 20.

The template generator 14 generates a graphical template that can be used for the display. The template maps the configuration items (CI) from (CI) database 22 that will be monitored graphically during the automata execution. Components of an information system are referred to as configuration items. A CI can be any conceivable IT component, including software, hardware, documentation, and personnel, as well as any combination of them. A configuration management database (CMDB) is a database that contains all relevant information about the components of the information system used in an organization's IT services and the relationships between those components. A CMDB provides an organized view of data and a means of examining that data from any desired perspective.

The template generator 14 may also use tool specific codes obtained from database 23 to generate the template. The template includes the connections between the configuration items and a topology of the different configuration items. Mechanisms to generate templates for graphically displaying IT infrastructure are known. Any graphic format can be used for the template.

The graphical renderer 16 displays a given topology and any real-time updates on a user interface/display 25. Real-time in the application means that the automation execution status is updated on the user interface/display at the time the status is changed. The state analyzer 18 analyzes the state of the automata execution from the execution logs database 24 for the most recent execution state and identifies the states that are relevant for the configuration items that are being monitored. The near real-time is

The update generator 20 generates the updates to graphical view of the configuration items current state based on the execution. The update generator 20 provides the updated the graphical view to the graphical renderer 16 which updates the template. The updates may be rule-based or learned using machine learning based on historical data. In one embodiment, machine learning is used to update the graphs. The graph shows the network of the configuration items, and based on historical execution of the automation, different states of the configuration items can be updated in the graphical view.

The rules may be general or specific to a particular application. The update generator 20 can summarize the state changes based on a user role obtained from database 26 that contains, for example, standard operating procedure documents and technical documents. The user roles are from the native automation tool. The database is using for storing the execution information.

In one embodiment, the automata execution graphical rendering system 10 can dynamically adapt the level of detail on automation execution status based on the type of the user. The graphical rendering system will pick the information from the database dynamically.

For example, certain types of users may require more detail about the automation execution status, such as success, failed, request time or execution not responding, respectively. More details about the execution status could be specific steps that failed details of the environment where the automation was executed etc. A Delivery Project Executive may not need to know all the details, but a technical lead would like to understand next level of details.

The update generator 20 may be configured to provide the level of detail. A feedback loop 28 connects the input from the user interface/display 25 to the system 12. The automata execution graphical rendering system 10 is able to understand all steps of every execution in automation and display the live status of automation execution.

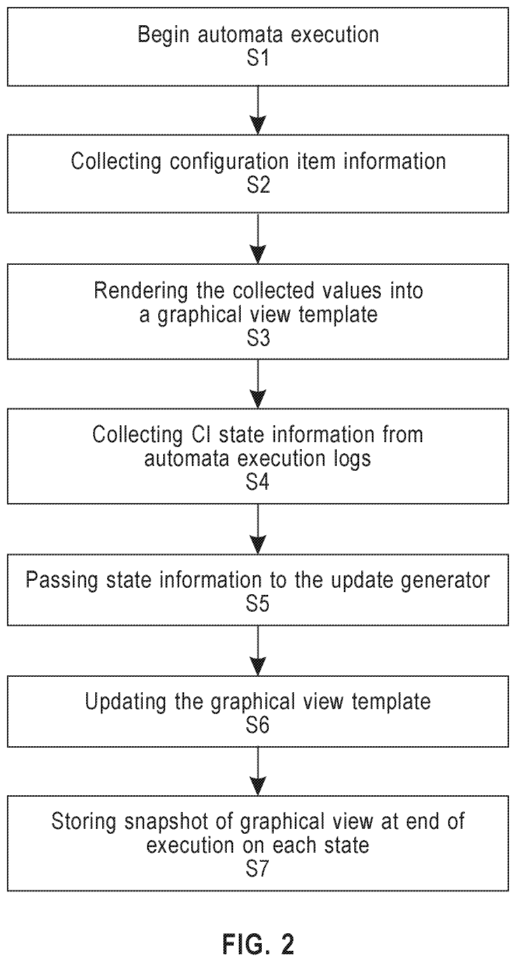

FIG. 2 is a flow diagram of one embodiment a method for graphical rendering of automata execution. In step S1 the automata execution is begun. In step S2 the template generator collects the configuration item information from the CI database 22. The configuration item information may include client code, connection definition, users, jumphosts, Wins server, endpoints, other servers or devices if any. The configuration item information may be obtained from CI database 22 and tool specific codes database 23. In Step S3, the graphical renderer 16 renders the collected values into an already developed template of a graphical view. In step S4, the state analyzer 18 collects each state information from the automata execution logs and in step S5 passes the state information to the update generator 20. In step S6, the update generator 20 updates the graphical view template in the graphical renderer 16. In one embodiment, the preconfigured conditions stored in the update generator 20 coverts the status into a graphical view. In step S7, at the end of execution on each state, a snapshot is stored which will create graphical result at end of the execution. At the end of the automata execution, the final graphical result is stored. The snapshot of the graphical template can be viewed at any point in time.

The system and method disclosed is an improvement over prior art automata graphical systems. The system and method disclosed herein simplifies the automata execution result by rendering it in a graphical view in which it is easy to understand how the automata is connecting to the endpoint. In this way, the transactions on the automata will be transparent. In one embodiment, the graphical view may also show how many endpoints are involved on the execution. If there is a connection failure or host not available it will be indicated clearly, which current systems are not capable of doping. In one embodiment, if any command failed to execute on any endpoint, it will be indicated with symbols. The graphical view will simplify the complex automata executions that will help the user account team and non technical managers to understand the behavior of the automata. As a result, there will be no need to depend on the error codes and execution logs.

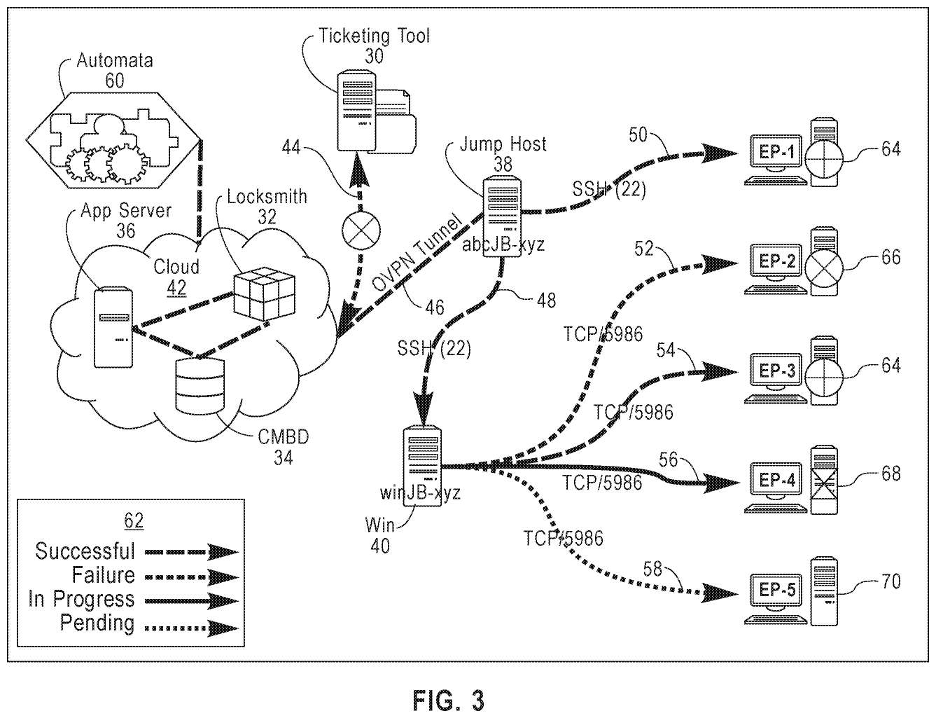

FIG. 3 is one embodiment of a graphical view of all the configuration items involved on an automation execution generated by the automata execution graphical rendering system 10. In the exemplary embodiment of FIG. 3, the user system is an IT management platform that includes a ticketing Tool 30, locksmith 32, configuration management database (CMDB) 34, App Server 36, JumpHost 38, Win Server 40 and endpoints EP-1, EP-2, EP-3, EP-4 and EP-5. In one embodiment, the App Server 36 contains the automata execution graphical rendering system 10. In one embodiment, the locksmith 32, service management database (SMBD) 34 and App Server 36 may be located in a cloud computing environment 42. The cloud 42 is connected to ticketing tool 30 via path 44 and to JumpHost 38 via PVPN path 46. JumpHost 38 is connected to Win Server 40 via SSH path 48 and to EP-1 via SSH path 50. Win Server 40 is connected to EP-2 via TCP path 52, to EP-3 via TCP path 54, to EP-4 via TCP path 56 and to EP-5 via TCP path 58. The automation tool 60 is connected to the IT management platform via the cloud 42.

In one embodiment, the paths will graphically indicate the status of execution, based on a graphical key 62. The graphical indication may be of any form such as colors, shadings, shapes or other known means. In ne embodiment, status shown may be successful, failure, in-progress and pending as shown in key 62. In one embodiment, each transition path will show the session and port number. If it is not available, it will show status as failure.

The success automata executions in FIG. 3 are shown to endpoints EP-1 and EP-3. These endpoints show the success with a graphic indication 64. A failure automata execution is shown to endpoint EP-2 with failure graphic 66. It is clearly showing the failure happened on the endpoint as the connection up to execution to Win Sever 42 is successful. In one embodiment, the graphical view can include various symbols to indicate the reason for the failure on the endpoints, such as to differentiate endpoint down, Win Server RM configuration not done and a timeout issue. An in-progress automata execution is shown to endpoint EP-4, which has a corresponding in-progress graphic 68. Once the timeout completes, the graphic for the path 56 and the endpoint graphic 68 will change to based on the result. A pending automata execution is shown at endpoint EP-5 which has pending graphic 70. The endpoints will be taken based on the input sequence on the automata.

The automation tool handles events, service requests and schedules automation for multiple clients across the global IT management platform of the user. The automata execution graphical rendering system 10 works efficiently on repeatable works or all kind of known errors and simplifies a lot of technical works. The end result is totally depending on each executions and success of each state on the automata. The automata execution log of prior systems cannot showcase the errors to others since only the CSI engineers can understand the results.

The graphical view representation provided by the automata execution graphical rendering system 10 will be helpful to understand all steps of every execution. Based on this graphical view, a developer can modify and develop the automata more efficiently. The automata execution graphical rendering system 10 will be very helpful when testing a complex automata on a various test scenarios.

It is to be understood that although this disclosure includes a cloud computing implementation 42 of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure that includes a network of interconnected nodes.

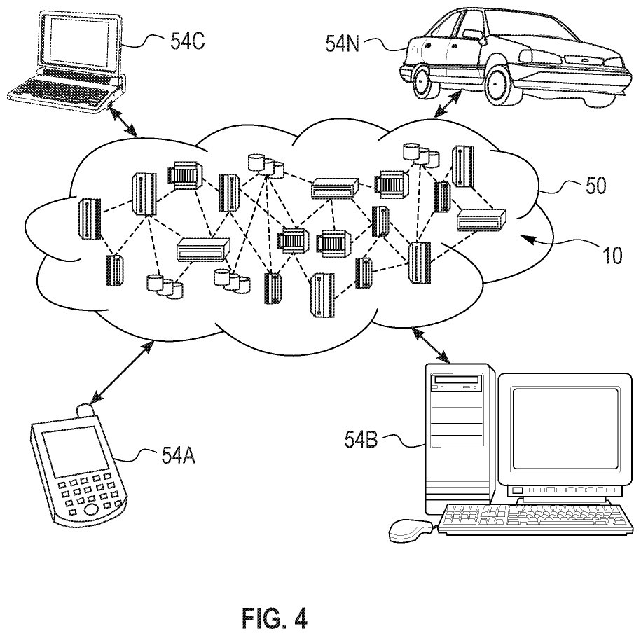

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

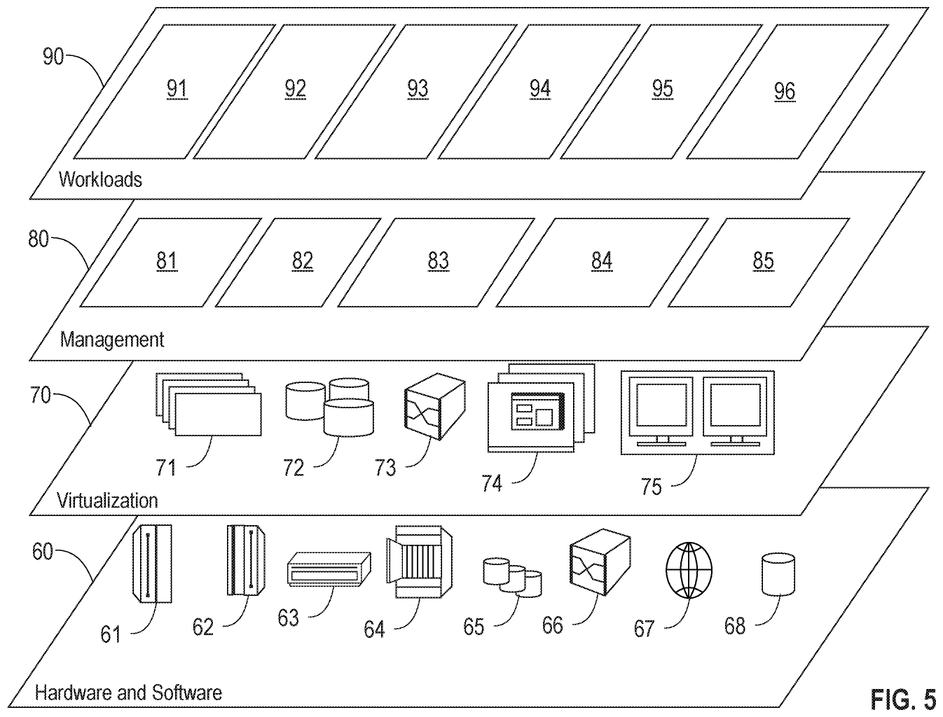

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below.

Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and automata execution graphical rendering 96.

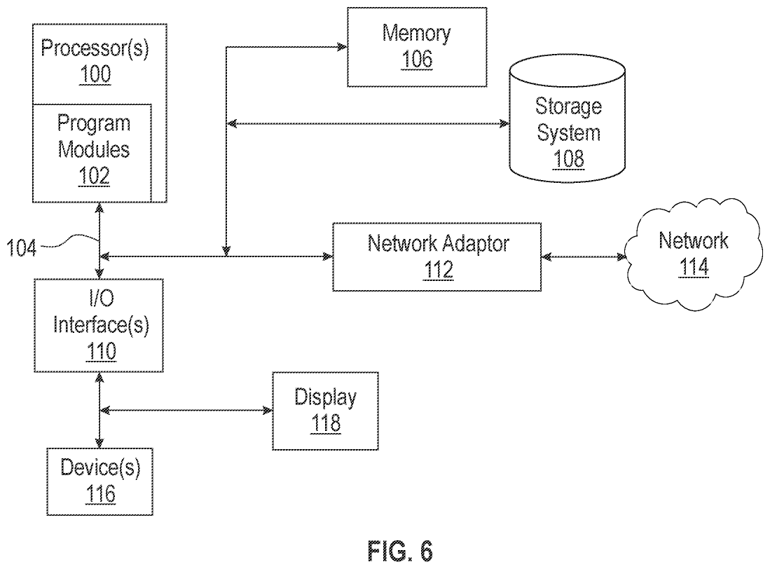

FIG. 6 illustrates a schematic of an example computer or processing system that may implement the method for automata execution graphical rendering in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 6 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 100, a system memory 106, and a bus 104 that couples various system components including system memory 106 to processor 100. The processor 100 may include a program module 102 that performs the methods described herein. The module 102 may be programmed into the integrated circuits of the processor 100, or loaded from memory 106, storage device 108, or network 114 or combinations thereof.

Bus 104 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 106 can include computer system readable media in the form of volatile memory, such as random access memory (RAM) and/or cache memory or others. Computer system may further include other removable/non-removable, volatile/non-volatile computer system storage media. By way of example only, storage system 108 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 104 by one or more data media interfaces.

Computer system may also communicate with one or more external devices 116 such as a keyboard, a pointing device, a display 118, etc.; one or more devices that enable a user to interact with computer system; and/or any devices (e.g., network card, modem, etc.) that enable computer system to communicate with one or more other computing devices. Such communication can occur via Input/Output (I/O) interfaces 110.

Still yet, computer system can communicate with one or more networks 114 such as a local area network (LAN), a general wide area network (WAN), and/or a public network (e.g., the Internet) via network adapter 112. As depicted, network adapter 112 communicates with the other components of computer system via bus 104. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

In addition, while preferred embodiments of the present invention have been described using specific terms, such description is for illustrative purposes only, and it is to be understood that changes and variations may be made without departing from the spirit or scope of the following claims.

What is claimed is:

1. A computer implemented method for generating a graphical view of automata execution by an automatonic information technology (IT) management tool configured to monitor an IT infrastructure, the tool including a configuration items (CI) database containing configuration items that represent elements of the IT infrastructure, the tool including an execution log database configured to store automata execution status resulting from automatonic monitoring of the configuration items by the tool, the method comprising:
collecting CI information values from the CI database;
projecting the collected CI values into a template of a graphical view of the IT infrastructure generated by the tool;
collecting state information values of the automata execution status from the execution log database;
converting the state information values of the automata execution status into a graphic information; and
displaying the graphic information of the automata execution status on the graphical view of the IT infrastructure.

2. The computer implemented method according to claim 1, further comprising identifying particular configuration items being monitored and collecting state information values from the identified particular configuration items.

3. The computer implemented method according to claim 1, wherein collecting state information values includes updating the state information values in response to updates to the automata execution status in the execution log database.

4. The computer implemented method according to claim 3, wherein converting the state information values includes generating updated graphic information based on the updated the state information values.

5. The computer implemented method according to claim 4, wherein displaying the graphic information includes updating the graphical view of the IT infrastructure based on the updated graphic information.

6. The computer implemented method according to claim 1, wherein the method is performed in a cloud environment.

7. A computer system for generating a graphical view of automata execution by an automatonic information technology (IT) management tool configured to monitor an IT infrastructure, the tool including a configuration items (CI) database containing configuration items that represent elements of the IT infrastructure, the tool including an execution log database configured to store automata execution status resulting from automatonic monitoring of the configuration items by the tool, the computer system comprising:
one or more computer processors;
one or more non-transitory computer-readable storage media;
program instructions, stored on the one or more non-transitory computer-readable storage media, which when implemented by the one or more processors, cause the computer system to perform the steps of:
collecting CI information values from the CI database;
projecting the collected CI values into a template of a graphical view of the IT infrastructure generated by the tool;
collecting state information values of the automata execution status from the execution log database;
converting the state information values of the automata execution status into a graphic information; and
displaying the graphic information of the automata execution status on the graphical view of the IT infrastructure.

8. The computer system according to claim 7, further comprising identifying particular configuration items being monitored and collecting state information values from the identified particular configuration items.

9. The computer system according to claim 7, wherein collecting state information values includes updating the state information values in response to updates to the automata execution status in the execution log database.

10. The computer system according to claim 9, wherein converting the state information values includes generating updated graphic information based on the updated the state information values.

11. The computer system according to claim 10, wherein displaying the graphic information includes updating the graphical view of the IT infrastructure based on the updated graphic information.

12. The computer system according to claim 7, wherein the method is performed in a cloud environment.

13. A computer program product comprising:
program instructions on a computer-readable storage medium, where execution of the program instructions using a computer causes the computer to perform a method for generating a graphical view of automata execution by an automatonic information technology (IT) management tool configured to monitor an IT infrastructure, the tool including a configuration items (CI) database containing configuration items that represent elements of the IT infrastructure, the tool including an execution log database configured to store automata execution status resulting from automatonic monitoring of the configuration items by the tool, the method comprising:
collecting CI information values from the CI database;
projecting the collected CI values into a template of a graphical view of the IT infrastructure generated by the tool;
collecting state information values of the automata execution status from the execution log database;
converting the state information values of the automata execution status into a graphic information; and
displaying the graphic information of the automata execution status on the graphical view of the IT infrastructure.

14. The computer program product according to claim 13, further comprising identifying particular configuration items being monitored and collecting state information values from the identified particular configuration items.

15. The computer program product according to claim 13, wherein collecting state information values includes updating the state information values in response to updates to the automata execution status in the execution log database.

16. The computer program product according to claim 15, wherein converting the state information values includes generating updated graphic information based on the updated the state information values.

17. The computer program product according to claim 4, wherein displaying the graphic information includes updating the graphical view of the IT infrastructure based on the updated graphic information.

18. The computer program product according to claim 1, wherein the method is performed in a cloud environment.
